(19) United States
(12) Patent Application Publication
(10) Pub. No.: US 2005/0186834 A1
(43) Pub. Date: Aug. 25, 2005

(54) Electric apparatus with insulating barrier having simplified attaching structure

(75) Inventors: Yoshimasa Tanikawa, Takefu-city (JP); Tomo Kawahara, Takefu-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Takefu-city (JP)

(21) Appl. No.: 11/058,215

(22) Filed: Feb. 16, 2005

(30) Foreign Application Priority Data
Feb. 23, 2004 (JP) 2004-046140

(51) Int. Cl. H01R 4/38

(52) U.S. Cl. 439/455

(57) ABSTRACT

The invention provides an electric apparatus with an insulating barrier having simplified attaching structure that is inexpensive, has high general versatility, and enables the fabrication process to be shortened, in which the insulating barrier performs insulation between a power circuit provided within a cabinet of the electric apparatus and the cabinet.

An insulating plate 11 of an insulating barrier 10 is formed in such a manner that a prescribed creepage distance is generated between a component part 51 of a primary circuit portion 22a and a cabinet 21, an attaching opening 12a for fitting to a cable fixing bush 23 is formed on a side portion 12, and the insulating barrier is attached to an electric apparatus 20 by fitting the attaching opening 12a to the cable fixing bush 23.

The present application is based on and claims priority of Japanese patent application No. 2004-046140 filed on Feb. 23, 2004, the entire contents of which are hereby incorporated by reference.

### BACKGROUND OF THE INVENTION

1. Field of the Invention

The present invention relates to an electric apparatus having an insulating barrier provided in a cabinet of the electric apparatus that performs the insulation between the cabinet of the electric apparatus and a power circuit provided in the cabinet of the electric apparatus.

2. Description of the Related Art

In recent years, electric apparatuses have become smaller and thinner in order to increase the competitiveness of the products. Because the interior of such small and thin designed electric apparatuses and the like do not have sufficient space, various devices and parts are mounted at high densities. Naturally, the gap between a cabinet, which is an outer case that houses component parts of the electronic apparatus and the like, and parts housed in the cabinet becomes narrow.

On the other hand, a prescribed insulation distance specified in a safety standard is required between a part where human beings touch (that is, a cabinet of an electric apparatus) and a high-voltage portion, such as a primary circuit of commercial power supply voltage.

Therefore, when the prescribed insulation distance specified in a safety standard is to be met by a spatial distance, it is necessary to provide a space corresponding to this spatial distance within the electric apparatus and hence it becomes impossible to meet requirements for small design and thin design of products. Therefore, it has hitherto been a practice to insert an insulator between the cabinet of an electric apparatus and a high-voltage portion, such as a primary circuit of commercial power supply voltage, thereby to increase the creepage distance between the cabinet and the high-voltage portion, whereby requirements for small design and thin design of products are met, with the prescribed insulation distance specified in a safety standard in between.

As a conventional technique related to insulators provided in the interior of an electronic apparatus, the Japanese Patent Laid-Open Publication No. 11-274786 (Patent Document 1) discloses a technique related to an attaching structure of an insulating sheet that insulates a shielding plate of a circuit board of an electric apparatus. The Japanese Patent Laid-Open Publication No. 11-307958 (Patent Document 2) discloses a technique that facilitates the fixing of an insulating plate by an arrangement of a power circuit board, the first signal circuit processing board, and the second signal circuit processing board.

As described above, it has hitherto been a practice to insert an insulator between the cabinet of an electric apparatus and a high-voltage portion, such as a primary circuit of commercial power supply voltage, in order to meet the requirements for small design and thin design of products while meeting the prescribed insulation distance specified in a safety standard. In this case, naturally, it is necessary to fix the insulator to the electric apparatus, and when this fixing is performed by fastening with screws, or adhesion with double-faced adhesive tape and the like, it has posed problems in terms of workability and a cost increase by using number of component parts, working of fixed portions, changes in design, and the like.

According to the attaching structures of an insulator disclosed in Patent Document 1 and Patent Document 2, new component parts such as screws are unnecessary compared to the fixing by fastening with screws and adhesion with double-faced adhesive tape, and a cost reduction is achieved in this respect. However, additionally, the working of aboard and the working of a shielding plate are necessary and besides, it could not be said that the workability during installation is good.

The present invention is devised in view of the above-described various problems and it aims at providing an electric apparatus with an insulating barrier having simplified attaching structure that is inexpensive, has high general versatility, and enables the working process to be shortened.

### SUMMARY OF THE INVENTION

The electric apparatus with an insulating barrier having simplified attaching structure in the first aspect of the invention is an electric apparatus with an insulating barrier having simplified attaching structure provided within a cabinet of the electric apparatus to perform insulation between the cabinet of the electric apparatus and a power circuit provided within the electric apparatus, in which the cabinet is provided with a power cord pull-out opening to pull out a power cord having a cable fixing bush, wherein the cable fixing bush that fits into the power cord pull-out opening is mounted to the power cord, an attaching opening for the cable fixing bush is formed in the insulating barrier, and the insulating barrier is attached to the cabinet by fitting the cable fixing bush into the power cord pull-out opening of the cabinet and the attaching opening of the insulating barrier.

According to the above-described arrangement, by fitting an attaching opening provided in an insulating barrier having simplified structure to a cable fixing bush provided in a power cord of an electric apparatus, the insulating barrier having simplified structure is fixed to the electric apparatus.

The electric apparatus with an insulating barrier having simplified attaching structure in the second aspect of the invention according to the electric apparatus with an insulating barrier having simplified attaching structure in the first aspect of the invention, is an annular groove part formed in the cable fixing bush where the insulating barrier is attached to the cabinet by fitting this groove part into the power cord pull-out opening where the attaching opening.

The electric apparatus with an insulating barrier having simplified attaching structure in the third aspect of the invention according to the electric apparatus with an insulating barrier having simplified attaching structure in the first or second aspect of the invention, provides an insulating barrier comprising a plate-like insulator that is formed in such a manner that the gap between the cabinet and a component that constitutes a primary circuit of the power circuit has at least a prescribed creepage distance, and a plate-like side portion that has the attaching opening substantially orthogonal to the insulator.

According to the above-described arrangement, the attaching opening formed on a plate-like side portion is fitted to the cable fixing bush provided in the power cord of the electric apparatus and the insulating barrier having simplified attaching structure is fixed to the electric apparatus, with the result that at least a prescribed creepage distance is formed between the cabinet and a component part that constitutes a primary circuit of the power circuit.

The electric apparatus with an insulating barrier having simplified attaching structure in the fourth aspect of the invention according to the electric apparatus with an insulating barrier having simplified attaching structure in the third aspect of the invention, have the plate-like insulator and the plate-like side portion monolithically molded from polycarbonate in which the plate thickness of the plate-like insulator is not less than 0.5 mm.

According to the above-described arrangement, the plate-like insulator is formed by polycarbonate having a thickness of not less than 0.5 mm and the insulating properties and flame retardance of the plate-like insulator are satisfied.

The electric apparatus with an insulating barrier having simplified attaching structure in the fifth aspect of the invention according to the electric apparatus with an insulating barrier having simplified attaching structure in the third aspect of the invention, have the plate-like insulator and the plate-like side portion monolithically molded from vinyl chloride in which the plate thickness of the plate-like insulator is not less than 0.42 mm.

According to the above-described arrangement, the plate-like insulator is formed by vinyl chloride having a thickness of not less than 0.42 mm and the insulating properties and flame retardance of the plate-like insulator are satisfied.

As in the first aspect of the invention, according to the electric apparatus with an insulating barrier having simplified attaching structure provided within a cabinet of the electric apparatus to perform insulation between the cabinet of the electric apparatus and a power circuit provided within the electric apparatus, in which the cabinet is provided with a power cord pull-out opening to pull out a power cord having a cable fixing bush, wherein the cable fixing bush that fits into the power cord pull-out opening is mounted to the power cord, an attaching opening for the cable fixing bush is formed in the insulating barrier, and the insulating barrier is attached to the cabinet by fitting the cable fixing bush into the power cord pull-out opening of the cabinet and the attaching opening provided in the insulating barrier, by fitting the attaching opening provided in the insulating barrier having simplified attaching structure to the cable fixing bush that is provided originally in the power cord of the electric apparatus, the insulating barrier having simplified attaching structure is fixed to the electric apparatus with low cost without the use of number of component parts such as screws, compared to the insulating barrier which is fixed to the electric apparatus by fastening with screws, adhesion with double-faced adhesive tape, and the like. Further, because modifications to other component parts (such as providing new screw holes for fastening the screws, a new slit to hold an insulating sheet, and the like) are unnecessary, a cost reduction can be achieved with high general versatility provided. Furthermore, excellent workability is achieved because the insulating barrier having simplified structure is fixed to the electric apparatus only by fitting the attaching opening to the cable fixing bush.

As in the third aspect of the invention, according to the electric apparatus with an insulating barrier having simplified attaching structure as described in claim 1 or 2, the insulating barrier comprises a plate-like insulator that is formed in such a manner that the gap between the cabinet and a component that constitutes a primary circuit of the power circuit has at least a prescribed creepage distance, and a plate-like side portion that has the attaching opening substantially orthogonal to the insulator, wherein a prescribed creepage distance is formed by the insulating barrier having simplified attaching structure between a component that constitutes the primary circuit of the power circuit, which becomes a high-voltage portion, and the cabinet of the electric apparatus where human beings can touch, so that a prescribed insulation distance specified in a safety standard can be met with satisfaction, and at the same time, the spatial distance between the cabinet and the power circuit can be shortened as much as possible, with the result that small design and thin design of the electric apparatus can be ensured. In addition, it is necessary to provide the plate-like side portion substantially orthogonal to the insulator with a minimum of one surface in which the attaching opening is formed, in which the insulating barrier having simplified attaching structure has high openness and does not cover the power circuit portion that generates heat, thereby preventing a temperature rise in the power circuit portion from being accelerated.

As in the fourth aspect of the invention, according to the electric apparatus with an insulating barrier having simplified attaching structure as described in claim 3, the plate-like insulator and the plate-like side portion are monolithically molded from polycarbonate and the plate thickness of the plate-like insulator is not less than 0.5 mm, wherein the insulating barrier having simplified structure is monolithically molded from polycarbonate having high insulating properties, so that the result that the insulating properties can be satisfied and the cost can be reduced. Furthermore, the electric apparatus can have a combustion category UL94V-0 of the UL safety standard and the flame retardance can also be satisfied.

As in the fifth aspect of the invention, according to the electric apparatus with an insulating barrier having simplified attaching structure as described in claim 3, the plate-like insulator and the plate-like side portion are monolithically molded from vinyl chloride and the plate thickness of the plate-like insulator is not less than 0.42 mm, wherein the insulating barrier having simplified structure is monolithically molded from vinyl chloride having high insulating properties, so that the insulating properties can be satisfied and the cost can be reduced. Furthermore, the electric apparatus can have a combustion category UL94V-0 of the UL safety standard and the flame retardance can also be satisfied.

### BRIEF DESCRIPTION OF THE DRAWINGS

FIGS. 1(A), 1(B) and 1(C) are a perspective view, a side view, and a front view, respectively, of an insulating barrier having simplified attaching structure in Embodiment 1;

FIG. 2 is a perspective view that schematically shows part of a DVD recording/reading device of Embodiment 1 in an exploded condition;

FIG. 3 is an exploded perspective view that shows an enlarged attaching part of the insulating barrier 10 of the DVD recording/reading device of Embodiment 1;

FIG. 4 is a perspective view that shows an enlarged attaching part of the insulating barrier 10 of the DVD recording/reading device of Embodiment 1;

FIG. 5(A) is a sectional view taken along the line A-A of FIG. 4 and FIG. 5(B) is a sectional view taken along the line B-B of FIG. 4;

FIGS. 6(A), 6(B), and 6(C) are a perspective view, a side view, and a front view, respectively, of an insulating barrier having simplified attaching structure in Embodiment 2;

FIGS. 7(A), 7(B) and 7(C) are a perspective view, a side view, and a front view, respectively, of an insulating barrier having simplified attaching structure in Embodiment 3.

### DETAILED DESCRIPTION OF THE PREFERRED EMBODIMENTS

Now the preferred embodiments of the invention will be described below by referring to the drawings. Please not that the following embodiments are merely examples for embodying the present invention and are not intended to limit the invention to within the scopes of the embodiments.

### Embodiment 1

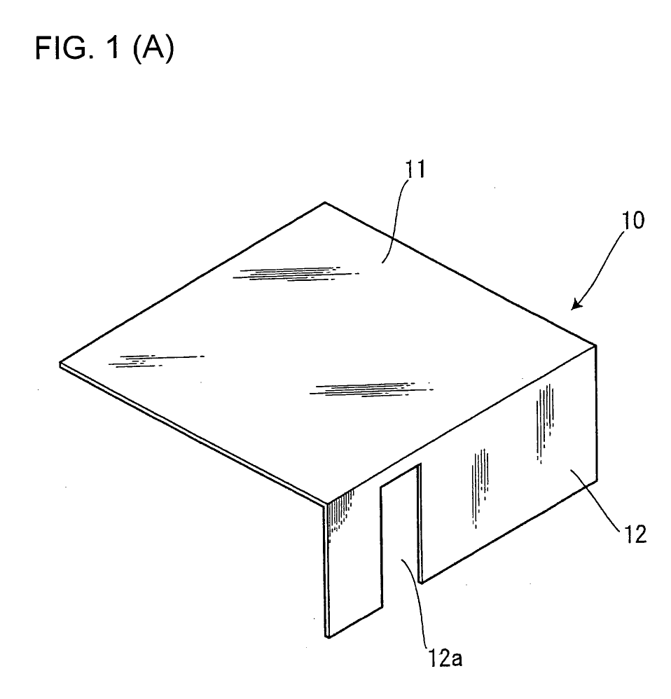

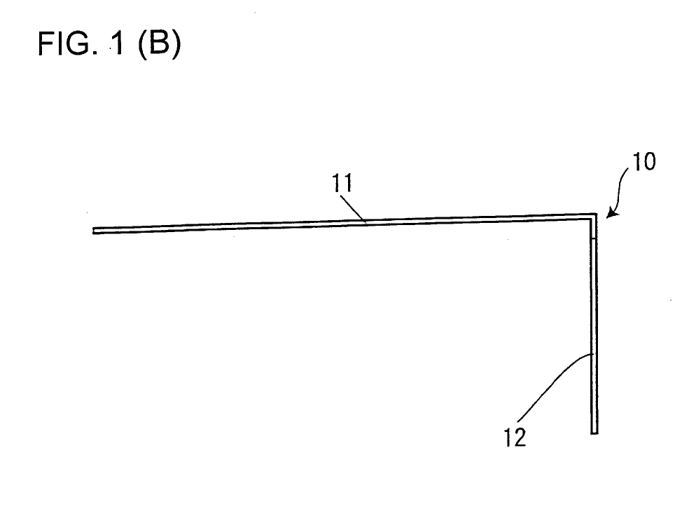

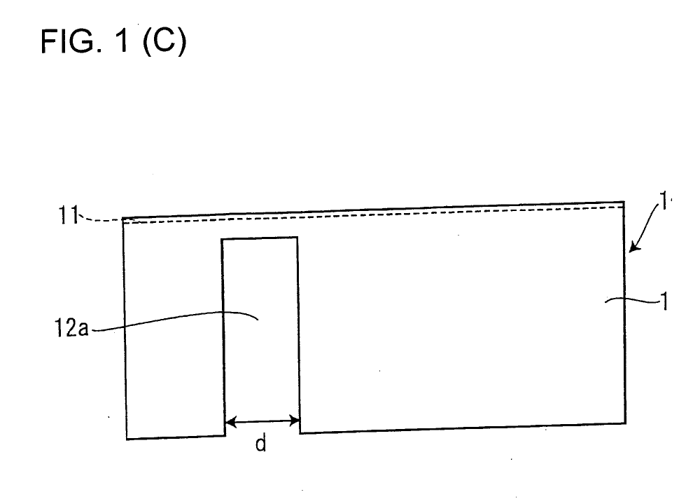

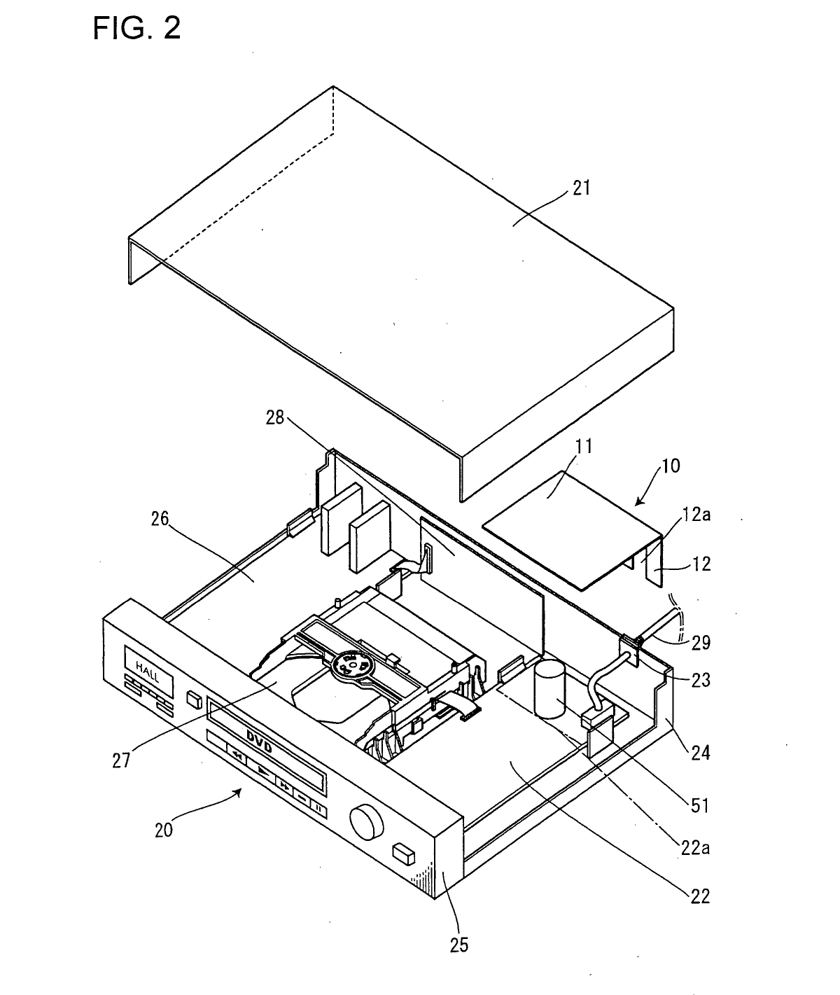

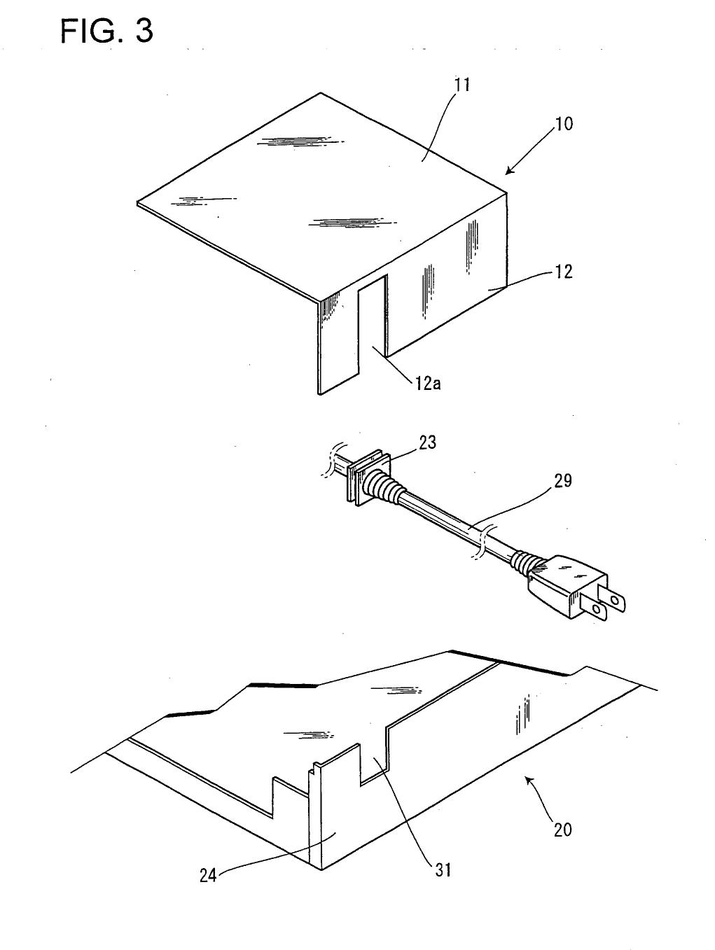

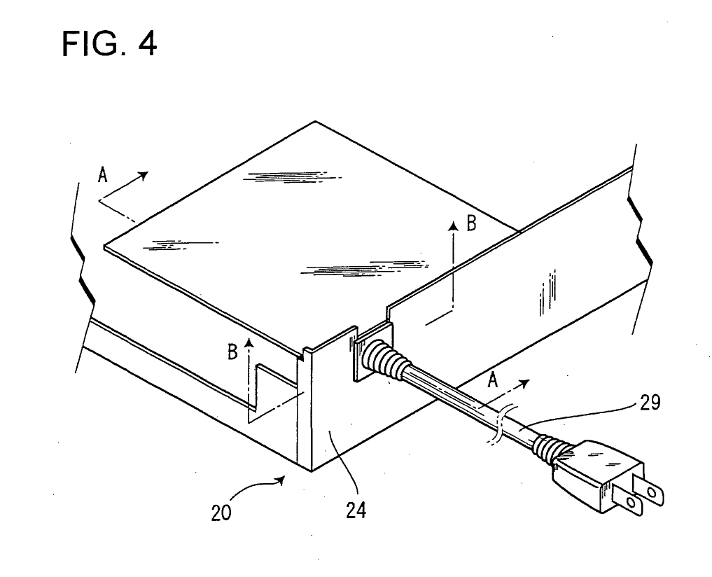

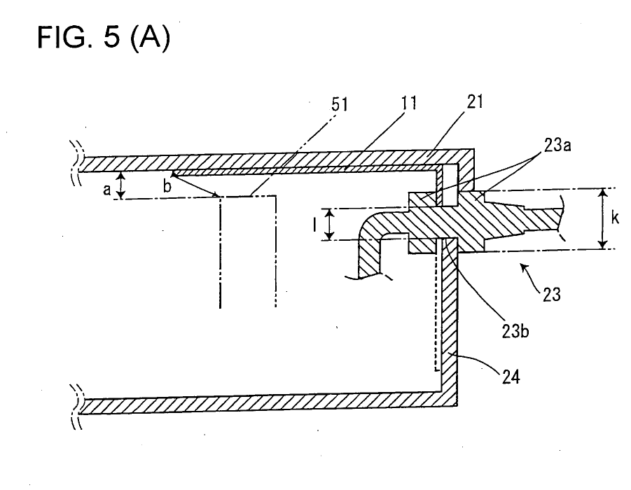

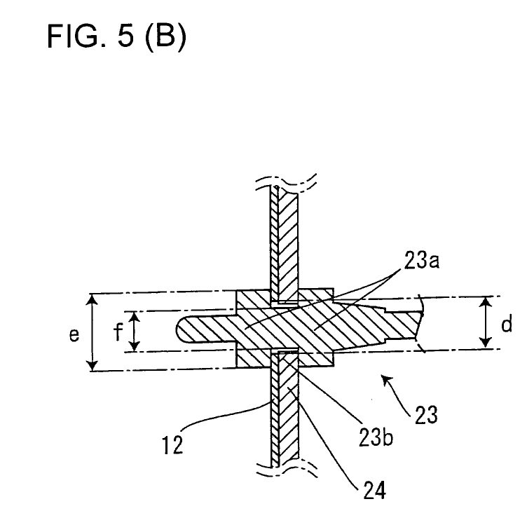

FIGS. 1(A), 1(B) and 1(C) are a perspective view, a side view, and a front view, respectively, of an insulating barrier having simplified attaching structure in Embodiment 1. FIG. 2 is a perspective view that schematically shows part of an electric apparatus (a DVD recording/reading device) of this embodiment in an exploded condition. FIGS. 3 and 4 are each an exploded perspective view that shows an enlarged attaching part of the insulating barrier of the electric apparatus of this embodiment. FIG. 5(A) is a schematic sectional view taken along a vertical plane including the line A-A of FIG. 4 and FIG. 5(B) is a schematic sectional view taken along a horizontal plane including the line B-B of FIG. 4.

As shown in FIGS. 1(A), 1(B) and 1(C), an insulating barrier having simplified attaching structure 10 (hereinafter referred to simply as an insulating barrier 10) of this embodiment is formed in L shape by bending a plate-like side portion 12 that is formed in rectangular shape from one side of an insulating plate (a plate-like insulator) 11 that is formed in rectangular shape in a substantially orthogonal direction, and an attaching opening 12a is cut into the side portion 12 from below in rectangular shape. Incidentally, in the insulating barrier 10 of this embodiment, both the insulating plate 11 and the side portion 12 have a plate thickness of 0.5 mm and the insulating plate 11 and the side portion 12 are monolithically molded from polycarbonate.

As shown in FIG. 2, a DVD recording/reading device 20, which is an example of an electric apparatus with an insulating barrier having simplified attaching structure of this embodiment, comprises as components a disk device 27, a power circuit board 22, a board 26 having a circuit that processes image and sound signals, a board 28 that processes external input/output signals etc., and the like, which are all housed in a cabinet. The cabinet is constituted by a chassis 24, a front panel 25, a cabinet 21, and the like. Incidentally, the power circuit board 22, the board 26 having a circuit that processes image and sound signals, the board 28 that processes external input/output signals etc., and the like, are simplified in the drawing. However, structurally, these boards are printed boards on which circuit patterns are printed where various electric and electronic parts and the like are mounted on. A primary circuit portion 22a on the power circuit board 22 is the part where a primary circuit of commercial power voltage is formed.

As shown in FIGS. 3 and 4, the insulating barrier 10 is installed in the DVD recording/reading device 20 by fitting the attaching opening 12a, along with the power cord pull-out opening 31, into an annular groove part 23b formed in a cable fixing bush 23. Therefore, as shown in FIG. 5(B), the width d of the attaching opening 12a is formed to be narrower than the width e of a flanged part 23a of the cable fixing bush 23 and wider than the width f of the groove part 23b thereof.

As shown in FIG. 2 and FIG. 5(A), the insulating plate 11 of the insulating barrier 10 is formed to have a size that provides a prescribed creepage distance b at least between a component part 51 that constitutes the primary circuit portion 22a of the power circuit board 22 and the cabinet 21, with the insulating plate 11 of the insulating barrier 10 being installed in the DVD recording/reading device 20. An example of “a prescribed creepage distance” is 6 mm, and forming the insulating plate 11 so as to obtain a creepage distance exceeding 6 mm enables the DVD recording/reading device 20 to have an insulation distance of not less than 6 mm between a high-voltage portion (the component part 51 that constitutes the primary circuit portion 22a) and a part where human beings touch (cabinet 21), and it is possible to shorten the spatial distance a as much as possible. Incidentally, the component part 51 is not intended to show only a specific part of the primary circuit portion 22a, and a prescribed creepage distance (not less than 6 mm in this embodiment) is to be ensured between an arbitrary component part that constitutes the primary circuit portion 22a and the cabinet 21.

According to the above-described arrangement, means for attaching the insulating barrier 10 to the electric apparatus (DVD recording/reading device 20) does not require new component parts such as screws or double-faced adhesive tape and it is unnecessary to newly work the chassis 24, the cabinet 21, or the power circuit board 22, and the like. Therefore, the cost is reduced and the electric apparatus can have high general versatility. Further, as shown in FIGS. 3 and 4, only by fitting the attaching opening 12a to the cable fixing bush 23, which is fitted into the power cord pull-out opening 31 of the chassis 24, so as to slide down from above, the power barrier 10 can be attached to the electric apparatus (DVD recording/reading device 20), and therefore, excellent workability is achieved. As described above, because it is possible to shorten the spatial distance a (the distance between an arbitrary component part that constitutes the primary circuit portion 22a and the cabinet 21) as much as possible while satisfying a prescribed insulation distance, small and thin design of the DVD recording/reading device 20 can be ensured. In addition, because the insulating barrier 10 has a shape of high openness and is not structured to encapsulate the power circuit board 22, the disadvantage that a temperature rise of the power circuit board 22 is accelerated scarcely occurs.

Although in this embodiment the insulating plate 11 and the side portion 12 are monolithically molded, the insulating plate 11 and the side portion 12 may be separately molded and then jointed together and is not limited to the monolithically molding process. Therefore, the insulating plate 11 and the side portion 12 may be formed from different materials and the thickness of the two may be different.

### Embodiment 2

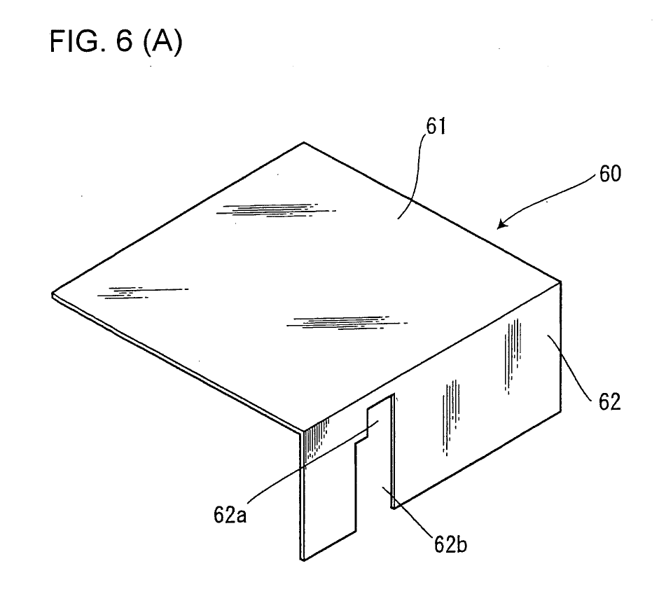

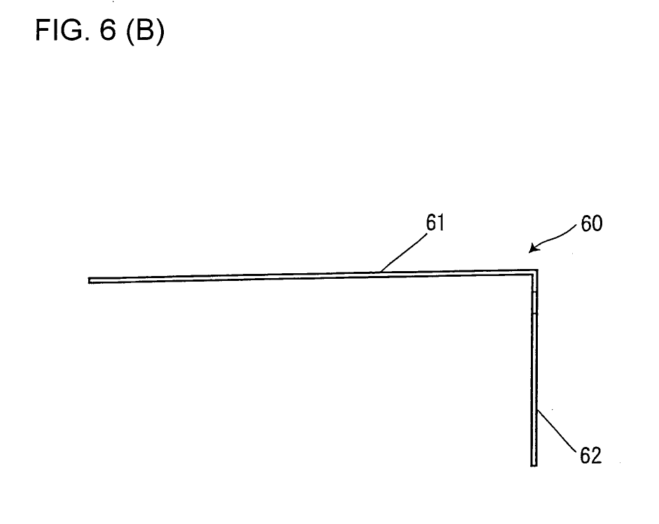

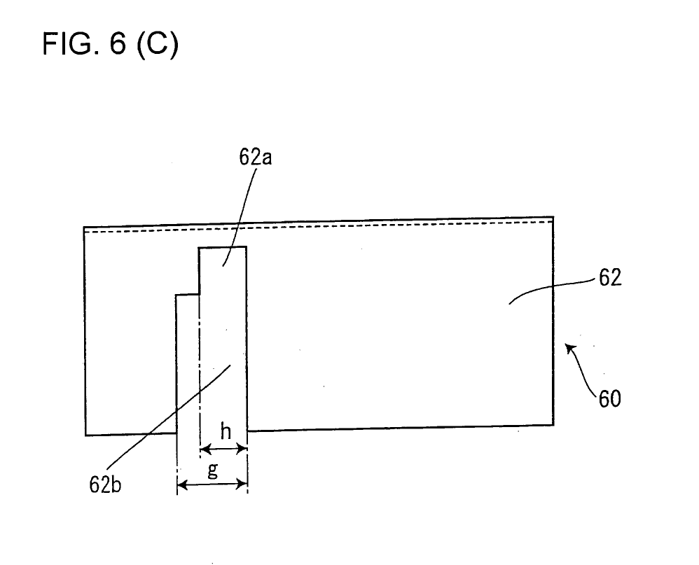

FIGS. 6(A), 6(B), and 6(C) are a perspective view, a side view, and a front view, respectively, of an insulating barrier having simplified attaching structure in Embodiment 2. Please note that because an example of an electric apparatus is the same DVD recording/reading device 20 as in Embodiment 1, the same reference numbers as in Embodiment 1 are used, and the description of the electric apparatus is omitted here.

As shown in FIGS. 6(A), 6(B), and 6(C), an insulating barrier having simplified attaching structure 60 (hereinafter referred to simply as an insulating barrier 60) of this embodiment is formed in such a manner that an insulating plate (a plate-like insulator) 61 that is formed in rectangular shape and a plate-like side portion 62 that is formed in rectangular shape are formed to be substantially orthogonal at one side, an introduction opening 62b is cut into the side portion 62 upwards from below in rectangular shape, and furthermore an attaching opening 62a is cut into the deepest portion of the introduction opening 62b in rectangular shape. Incidentally, in the insulating barrier 60 of this embodiment, both the insulating plate 61 and the side portion 62 have a plate thickness of 0.42 mm and both the insulating plate 61 and the side portion 62 are monolithically molded from vinyl chloride.

The insulating plate 61 of the insulating barrier 60 is formed to provide a prescribed creepage distance b at least between a component part 51 that constitutes the primary circuit portion 22a of the power circuit board 22 and the cabinet 21, with the insulating plate 61 of the insulating barrier 10 being installed in the DVD recording/reading device 20. This concept is the same as the concept of Embodiment 1 and, therefore, the description thereof is omitted here.

The width g of the introduction opening 62b formed in the side portion 62 is wider than the width e of a flanged part 23a of the cable fixing bush 23 and the width h of the attaching opening 62a is narrower than the width e of the flanged part 23a of the cable fixing bush 23 and wider than the width f of the groove part 23b thereof as in Example 1. According to this arrangement, in the work of fixing the insulating barrier 60 by engaging the insulating barrier 60 so as to slide down from the upper part of the DVD recording/reading device 20, it is unnecessary to slide the insulating barrier 60 while fitting the insulating barrier 60 to the cable fixing bush 23 in the portion of the introduction opening 62b, and the insulating barrier 60 can be installed in the DVD recording/reading device 20 by fitting the insulating barrier 60 to slide over to the cable fixing bush 23 only in the portion of the introduction opening 62a. Therefore, an excellent workability is achieved.

### Embodiment 3

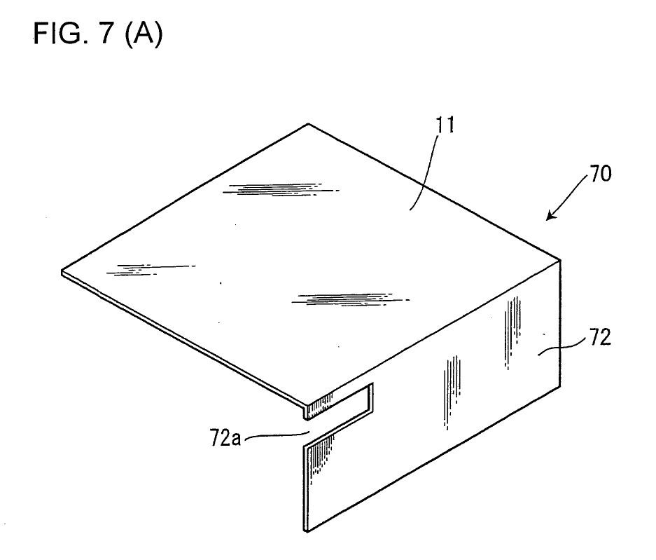

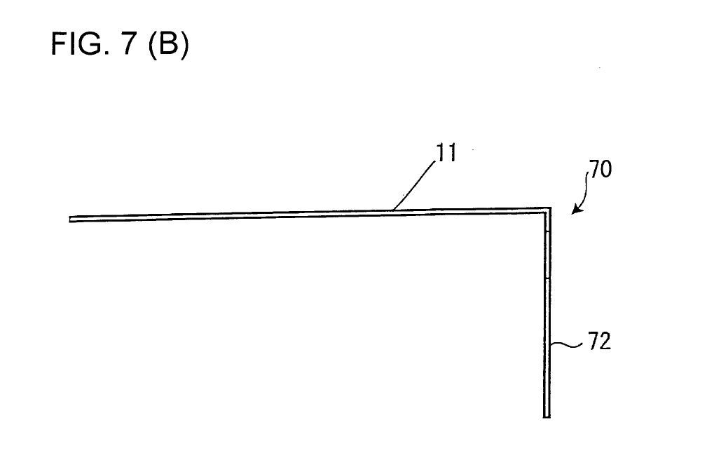

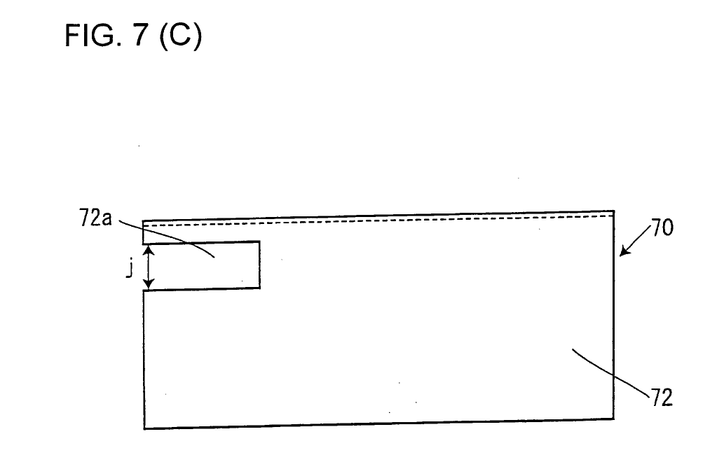

FIGS. 7(A), 7(B), and 7(C) are a perspective view, a side view and a front view, respectively, of an insulating barrier having simplified attaching structure in Embodiment 3. Please note that because an example of an electric apparatus is the same DVD recording/reading device 20 as in Embodiment 1, the same reference numbers as in Embodiment 1 are used, and the description of the electric apparatus is omitted here. In an insulating barrier 70 of this embodiment, both the insulating plate and the side portion have a plate thickness of 0.5 mm, and both the insulating plate and the side portion are monolithically molded from polycarbonate, and the insulating plate 11 is arranged in the same way as in Embodiment 1. Therefore, the same reference numbers are used and the description of the insulating barrier is omitted here.

As shown in FIGS. 7(A), 7(B), and 7(C), an insulating barrier having simplified attaching structure 70 (hereinafter referred to simply as an insulating barrier 70) of this embodiment is formed in such a manner that a plate-like insulating plate 11 and a plate-like side portion 72 which are both formed in rectangular shape are formed to be substantially orthogonal at one side, and an attaching opening 72a is cut sideways in rectangular form into the side portion 72. The height j of the attaching opening 72a is formed to be shorter than the height k of the flanged part 23a of the cable fixing bush 23 and longer than the height 1 of the groove part 23b thereof on the basis of the same concept as in Embodiments 1 and 2.

According to the above-described arrangement, the attaching of the insulating barrier 70 to the DVD recording/reading device 20 is performed by fitting the attaching opening 72a to the cable fixing bush 23, which is fitted into the power cord pull-out opening 31 of the chassis 24, so as to slide sideways. Some electric apparatuses have a folded portion, which is obtained, for example, by folding the top end of the chassis inward at a right angle. In such electric apparatuses, it may sometimes be difficult or impossible to slide the insulating barrier while fitting the insulating barrier to the cable fixing bush from the upper part of the chassis as in Embodiment 1. However, according to the insulating barrier 70 of this embodiment, the invention can be effectively applied to an electric apparatus that has a folded portion in the top end of the chassis.

To facilitate understanding, the above descriptions were given using a DVD recording/reading device as an example of an AV equipment. However, the embodiment of the invention is not limited to AV equipment and the invention can also be applied to electrical equipment such as home thermal equipment, heating, ventilation and air-conditioning equipment, and the like. AV equipment is, for example, a television set, a VTR, a DVD reading/recording device, an HDD reading/recording device, a radio, a record player, a cassette deck, a home theater system, an audio component system, an AV amplifier, an MD recording/reading device, a laser disc player, and the like. Home thermal equipment is, for example, an microwave oven, an oven, a toaster, an IH cooking heater, a pressing iron, and the like. Heating, ventilation, and air-conditioning equipment is, for example, an air conditioner, a fan heater, an electric heating blanket, an electric carpet, an electric fan, and the like. Furthermore, the electric apparatus related to the invention includes a refrigerator, a washing machine, a comforter dryer, a clothing dryer, a dehumidifier, a humidifier, a toilet seat with Washlet (which is an equipment to wash and clean using the shower and the dryer), a ventilation system, a personal computer, a cellular phone, a telephone set, a clock, a digital camera, a video camera, a vacuum cleaner, a game machine, projector, and the like.

1. An electric apparatus with an insulating barrier having simplified attaching structure provided within a cabinet of the electric apparatus to perform insulation between the cabinet of the electric apparatus and a power circuit provided within the electric apparatus, in which the cabinet is provided with a power cord pull-out opening to pull out a power cord having a cable fixing bush, wherein the cable fixing bush that fits into the power cord pull-out opening is mounted to the power cord, an attaching opening for the cable fixing bush is formed in the insulating barrier, and the insulating barrier is attached to the cabinet by fitting the cable fixing bush into the power cord pull-out opening of the cabinet and the attaching opening of the insulating barrier.

2. The electric apparatus with an insulating barrier having simplified attaching structure according to claim 1, wherein an annular groove part is formed in the cable fixing bush and the insulating barrier is attached to the cabinet by fitting this groove part into the power cord pull-out opening and the attaching opening.

3. The electric apparatus with an insulating barrier having simplified attaching structure according to claim 1 or 2, wherein the insulating barrier comprises a plate-like insulator that is formed in such a manner that the gap between the cabinet and a component that constitutes a primary circuit of the power circuit has at least a prescribed creepage distance, and a plate-like side portion that has the attaching opening substantially orthogonal to the insulator.

4. The electric apparatus with an insulating barrier having simplified attaching structure according to claim 3, wherein the plate-like insulator and the plate-like side portion are monolithically molded from polycarbonate and the plate thickness of the plate-like insulator is not less than 0.5 mm.

5. The electric apparatus with an insulating barrier having simplified attaching structure according to claim 3, wherein the plate-like insulator and the plate-like side portion are monolithically molded from vinyl chloride and the plate thickness of the plate-like insulator is not less than 0.42 mm.
